(19) United States
(12) Patent Application Publication
(10) Pub. No.: US 2006/0243384 A1
(43) Pub. Date: Nov. 2, 2006

(54) Method for adhesive bonding in electronic packaging

(75) Inventors: John Charles Ehmke, Garland, TX (US); Mark Christopher Fisher, Farmersville, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 11/118,934

(22) Filed: Apr. 29, 2005

(51) Int. Cl. B32B 37/00; B32B 37/12; B32B 38/00

(52) U.S. Cl. 156/292; 156/325; 156/329; 156/330; 156/331.7

(57) ABSTRACT

According to one embodiment of the invention, a method for adhesive bonding in electronic packaging includes disposing an adhesive on a substrate of an electronic package and engaging a cover with the adhesive such that a periphery of the cover engages the adhesive to form a cavity inside the cover. The method further includes raising the pressure outside the cavity, as a force is applied to the cover to compress the adhesive, to counteract the rise in pressure inside the cavity from a compressed volume of the cavity.

### TECHNICAL FIELD OF THE INVENTION

This invention relates generally to the field of integrated circuit packaging and, more specifically, to a method for adhesive bonding in electronic packaging.

### BACKGROUND OF THE INVENTION

Using adhesive that has viscous flow to bond together two surfaces to create closed cavities is useful for a variety of encapsulation schemes in electronic packaging, such as chipscale and waferscale MEMS packaging. A problem with this concept is that once the adhesive wets completely around the enclosed cavity, further reduction in adhesive thickness by the application of an external force results in an increase in internal pressure in the cavity. Increasing pressure in the cavity may cause the adhesive to be displaced or “blown out” of the bond line, thereby reducing or losing the cavity seal. Increasing pressure in the cavity may also limit the use of thermosetting adhesives, as heat necessary to cure these adhesives also causes internal pressure to rise and adhesive blow-out to occur.

### SUMMARY OF THE INVENTION

According to one embodiment of the invention, a method for adhesive bonding in electronic packaging includes disposing an adhesive on a substrate of an electronic package and engaging a cover with the adhesive such that a periphery of the cover engages the adhesive to form a cavity inside the cover. The method further includes raising the pressure outside the cavity, as a force is applied to the cover to compress the adhesive, to counteract the rise in pressure inside the cavity from a compressed volume of the cavity.

Some embodiments of the invention provide numerous technical advantages. Other embodiments may realize some, none, or all of these advantages. For example, a thin, high-strength, low-permeation, reproducible adhesive seal for an enclosed cavities in an electronic package may be achieved because the adhesive bond line experiences substantially the same pressure internal as well as external to the cavity. This prevents adhesive “blow-out,” and may allow the use of different types of adhesive materials, such as thermosetting adhesives.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIGS. 1A through 1C are a series of cross-sectional elevation views illustrating an example method of adhesive bonding in electronic packaging in accordance with an embodiment of the invention; and

FIG. 2 is a flowchart illustrating an example method of adhesive bonding in electronic packaging in accordance with an embodiment of the invention.

### DETAILED DESCRIPTION OF EXAMPLE EMBODIMENTS OF THE INVENTION

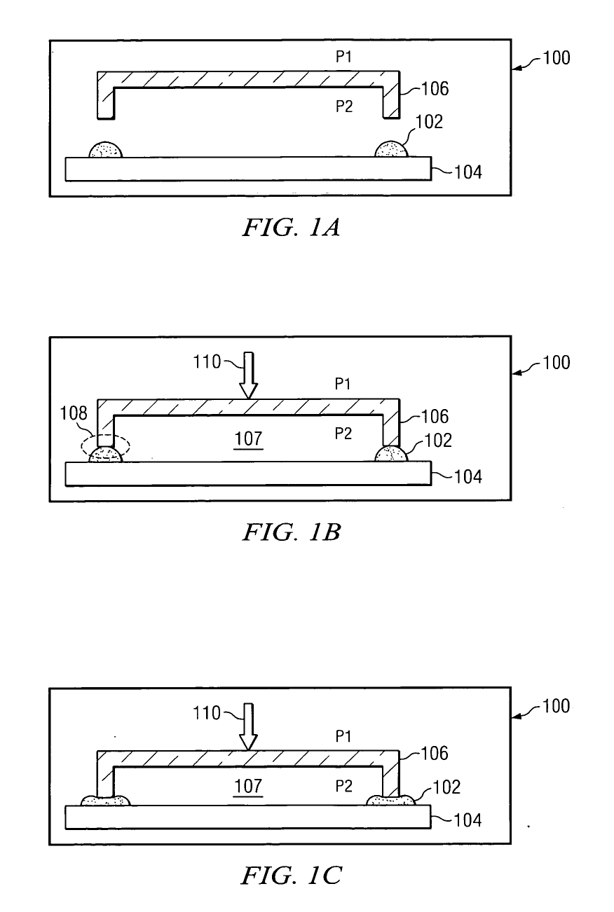

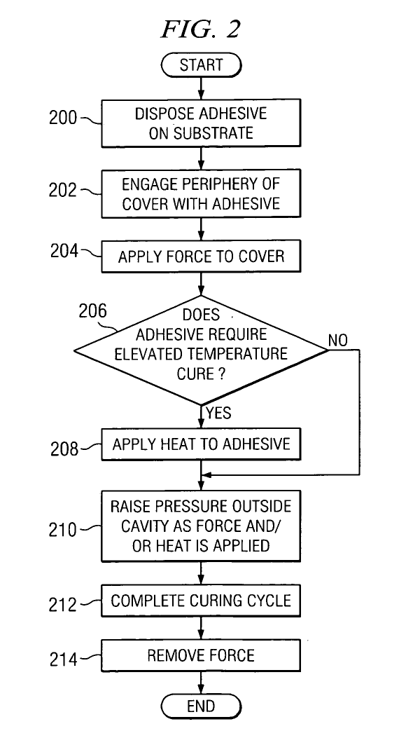

Example embodiments of the present invention and their advantages are best understood by referring now to FIGS. 1A through 2 of the drawings, in which like numerals refer to like parts.

FIGS. 1A-1C are a series of cross-sectional elevation views illustrating an example method of adhesive bonding in electronic packaging in accordance with an embodiment of the invention. Illustrated in FIGS. 1A-1C within a bonding chamber 100 are an adhesive 102 disposed on a substrate 104 and a cover 106.

Adhesive 102 functions to couple cover 106 to substrate 104. Any suitable adhesive is contemplated by the present invention for use as adhesive 102, such as an epoxy, an acrylic, a polyurethane, a silicone, and related co-polymers. In a more particular embodiment of the invention, adhesive 102 is formed from a UV-activated epoxy. Adhesive 102 may be deposited on substrate 104 in any suitable manner, such as screen printing, jetting, preform, or using a syringe. Any suitable amount of adhesive 102 may be disposed on substrate 104 in any suitable pattern.

Substrate 104 may be any suitable substrate associated with any suitable electronic package. For example, substrate 104 may be a silicon substrate, a ceramic substrate, a metal substrate, or other suitable substrate, having any suitable dimensions. In addition, any suitable electronic packages are contemplated by the present invention, such as a chipscale package, a waferscale package, a multi-chip module, or other suitable electronic packages. The present invention may be particularly suitable for a micro-electromechanical structure (“MEMS”) package, such as a digital micro mirror device (“DMD”).

Cover 106 functions to house electronic components (not explicitly illustrated) that are coupled to substrate 104 for protection from the environment. Cover 106 may have any suitable size and shape and may be formed from any suitable material, such as glass, ceramic, metal, or other suitable materials.

Also illustrated in FIG. 1A is a pressure, P1, that denotes the pressure within bonding chamber 100 outside a cavity 107 (FIGS. 1B and 1C) formed when cover 106 is coupled to substrate 104. A pressure, P2, denotes a pressure inside cavity 107. Before cover 106 engages adhesive 102, both P1 and P2 are equal. Both P1 and P2 may be any suitable pressures, such as below ambient, at ambient, or above ambient, as described in further detail below. Cavity 107 may be contained primarily within cover 106, as illustrated in FIGS. 1A-1C, or primarily within substrate 104, or within both.

Referring now to FIG. 1B, a periphery 108 of cover 106 is shown to be engaged with adhesive 102 to form cavity 107. This is the initial engagement of cover 106 with adhesive 102 before cover 106 compresses adhesive 102. Any suitable force 110 may be utilized to ensure the engagement of periphery 108 with adhesive 102. For example, force 110 may be a mechanical force. Once the full periphery 108 of cover 106 engages adhesive 102, then cavity 107 is formed and P1 continues to equal to P2 before cover 106 further compresses adhesive 102, as shown below in conjunction with FIG. 1C.

Referring to FIG. 1C, cover 106 is shown to be compressing adhesive 102 by further application of force 110. This compression of adhesive 102 causes a compressed volume of cavity 107, which raises pressure P2. Increasing pressure in cavity 107 may cause adhesive 102 to be “blown out,” thereby losing cavity seal. In addition, although not illustrated in FIGS. 1A-1C, heat may be applied to adhesive 102 in order to sufficiently cure adhesive 102. This heat used to cure adhesive 102 may further increase pressure P2, thereby potentially exacerbating the blow out of adhesive 102.

Thus, according to the teachings of one embodiment of the invention, pressure P1 outside cavity 107 is raised to counteract the rise in pressure P2 inside cavity 107 resulting from the compressed volume of cavity 107 and/or the heat applied to adhesive 102. For example, if P1 was initially at ambient pressure, then P1 is raised to somewhere above ambient pressure in order to counteract the increased pressure P2 inside cavity 107. In one embodiment of the invention, the rate of rise in pressure P1 substantially equals the rate of rise in pressure P2. However, any suitable rate and any suitable proportion are contemplated by the present invention. The increasing of pressure P1 may be facilitated in any suitable manner. In addition, P1 may be raised any suitable amount. In one embodiment, pressure P1 is raised to a range of about 10 to 100 millibars over its initial pressure.

Depending on the type of adhesive 102 utilized and/or the expected rise in pressure P2 in cavity 107, any suitable combination of pressure P1 and pressure P2 is contemplated by the present invention. For example, pressure P1 may initially be below ambient and then subsequently raised to ambient or above ambient. In another embodiment, pressure P1 may initially be above ambient and subsequently raised further above ambient. In an embodiment where adhesive 102 requires an elevated temperature curing cycle, pressure P1 may initially be somewhere below ambient pressure and then raised somewhere above ambient pressure.

Because adhesive 102 experiences substantially the same pressure inside cavity 107 as well as outside cavity 107, adhesive blow out may be prevented. In addition, the teachings of the present invention may allow the use of different types of adhesive materials, such as thermosetting adhesives in place of non-thermosetting types.

FIG. 2 is a flowchart illustrating an example method of adhesive bonding in electronic packaging in accordance with an embodiment of the invention. The example method begins at step 200 where adhesive 102 is disposed on substrate 104 of an electronic package. A periphery of cover 106 is engaged with adhesive 102, at step 202, by the application of force 110 to cover 106. Force 110 is further applied to cover 106 at step 204 in order to compress adhesive 102.

At decisional step 206, it is determined whether adhesive 102 requires elevated temperature curing. If not, then the method continues at step 210. If it does, then heat is applied to adhesive 102 as indicated by step 208 and then the method continues at step 210. If heat is applied, then the temperature inside cavity 107 may be raised to any suitable temperature. In a particular embodiment of the invention, the temperature inside cavity 107 is raised to between 50° C. and 225° C.

Referring now to step 210, pressure P1 outside cavity 107 is raised as force 110 is applied to cover 106 and/or heat is applied to adhesive 102 in order to counteract the rise in pressure P2 inside cavity 107. The curing cycle for adhesive 102 is then completed, as indicated by step 212, before force 110 is removed as indicated by step 214. After adhesive 102 is compressed by force 110 to its desired thickness, then force 110 may be removed or may be adjusted in such a manner that enough force is applied to cover 106 to keep it from moving during the curing cycle. This then ends the example method outlined in FIG. 2.

Although embodiments of the invention and their advantages are described in detail, a person skilled in the art could make various alterations, additions, and omissions without departing from the spirit and scope of the present invention, as defined by the appended claims.

What is claimed is:

1. A method for adhesive bonding in electronic packaging, comprising:
disposing an adhesive on a substrate of an electronic package;
engaging a cover with the adhesive such that a periphery of the cover engages the adhesive to form a cavity inside the cover; and
as a force is applied to the cover to compress the adhesive, raising the pressure outside the cavity to counteract the rise in pressure inside the cavity from a compressed volume of the cavity.

2. The method of claim 1, wherein the force is a mechanical force.

3. The method of claim 1, further comprising applying heat to the adhesive.

4. The method of claim 1, wherein raising the pressure comprises raising the pressure in a range of about ten millibars to one hundred millibars.

5. The method of claim 1, wherein the adhesive is formed from a material selected from the group consisting of an epoxy, an acrylic, a polyurethane, and a silicone.

6. The method of claim 1, wherein the substrate is formed from a material selected from the group consisting of silicon, ceramic, and metal.

7. The method of claim 1, wherein the cover is formed from a material selected from the group consisting of glass, ceramic, and metal.

8. A method for adhesive bonding in electronic packaging, comprising:
disposing an adhesive on a substrate of an electronic package;
engaging, at ambient pressure, a cover with the adhesive such that a periphery of the cover engages the adhesive to form a cavity inside the cover; and
as a force is applied to the cover to compress the adhesive, raising the ambient pressure outside the cavity to counteract the rise in pressure inside the cavity from a compressed volume of the cavity.

9. The method of claim 8, wherein the force is a mechanical force.

10. The method of claim 8, further comprising applying heat to the adhesive.

11. The method of claim 8, wherein raising the ambient pressure comprises raising the ambient pressure in a range of about ten millibars to one hundred millibars.

12. The method of claim 8, wherein the adhesive is formed from a material selected from the group consisting of an epoxy, an acrylic, a polyurethane, and a silicone.

13. The method of claim 8, wherein the substrate is formed from a material selected from the group consisting of silicon, ceramic, and metal.

14. The method of claim 8, wherein the cover is formed from a material selected from the group consisting of glass, ceramic, and metal.

15. A method for adhesive bonding in electronic packaging, comprising:
disposing an adhesive on a substrate of an electronic package;
engaging, at below ambient pressure, a cover with the adhesive such that a periphery of the cover engages the adhesive to form a cavity inside the cover;
applying a force to the cover to compress the adhesive;
applying heat to the adhesive; and
as the force is applied to the cover and the heat is applied to the adhesive, raising the below ambient pressure outside the cavity to an above ambient pressure to counteract the rise in pressure inside the cavity from a compressed volume of the cavity and a rise in temperature within the cavity.

16. The method of claim 15, wherein the force is a mechanical force.

17. The method of claim 15, wherein applying heat to the adhesive comprises raising the temperature within the cavity to between 50° C. and 225° C.

18. The method of claim 15, wherein the adhesive is formed from a material selected from the group consisting of an epoxy, an acrylic, a polyurethane, and a silicone.

19. The method of claim 15, wherein the substrate is formed from a material selected from the group consisting of silicon, ceramic, and metal.

20. The method of claim 15, wherein the cover is formed from a material selected from the group consisting of glass, ceramic, and metal.
